(19) United States
(12) Patent Application Publication
(10) Pub. No.: US 2010/0153884 A1
(43) Pub. Date: Jun. 17, 2010

(54) ENHANCED WEB TOOLBAR

(75) Inventors: Michael Chow, San Mateo, CA (US); Tim Rechin, San Carlos, CA (US); Martin Price, Volpedo (IT); Tussanee Garcia Shelton, San Mateo, CA (US); Joff Redfern, Palo Alto, CA (US); Luke Wroblewski, San Jose, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/333,937

(22) Filed: Dec. 12, 2008

(51) Int. Cl. G06F 3/048

(52) U.S. Cl. 715/841

(57) ABSTRACT

An enhanced toolbar is disclosed. The enhanced toolbar is not static but is rather updated dynamically. In one aspect, the enhanced toolbar has a bounded perimeter and comprises a plurality of icons visibly displayed on a display of a computing device. Each icon occupies a first space within the bounded perimeter of the toolbar. Upon a selection of a first icon in the plurality of icons by a user, the first space associated with the first icon expands horizontally along a longitudinal axis of the toolbar to display information in a second bounded space within the perimeter. The information is not visible absent the expansion.

### FIELD

The present disclosure relates to web toolbars, and more specifically to a dynamic web toolbar.

### BACKGROUND

Toolbars facilitate the navigation of the World Wide Web (“web”). In particular, a toolbar is displayed on a web browser and is used to navigate to web pages. Toolbars may contain a search box enabling a user to search the web for information about one or more terms using a particular search engine, such as Yahoo!® or Google®. Some toolbars also enable a user to customize the toolbar with one or more icons that are shortcuts to different web pages. For example, if a user often goes to the web page www.cnn.com, the user may add an icon to the user's toolbar that is a shortcut to this web site.

Even with this customization, however, toolbars generally remain static. Once a user customizes a toolbar with one or more icons, the toolbar does not typically change until the user decides to customize the toolbar again.

### SUMMARY

The present disclosure relates to an enhanced toolbar. The enhanced toolbar is not static but is rather updated dynamically. In one aspect, the enhanced toolbar has a bounded perimeter and comprises a plurality of icons visibly displayed on a display of a computing device. Each icon occupies a first space within the bounded perimeter of the toolbar. The first space associated with a first icon expands horizontally along a longitudinal axis of the toolbar to display information in a second bounded space within the perimeter. The expanding can occur upon a selection of the first icon by a user or automatically upon alert. The information is not visible absent the expansion.

The information can include text, a web link, and/or one or more additional icons. The information displayed can be based on past activity of a user accessing the toolbar or past activity of one or more other users different than the user. In one embodiment, the information displayed by the toolbar changes (e.g., after a period of time). The toolbar can indicate an alert to a first user that an activity has been performed by a second user. The alert may include an indication that an email has been sent from the second user to the first user. In one embodiment, the alert is configured based on one or more settings received from or associated with the first user. In one embodiment, the first icon (or any other icon of the toolbar) is received from a third party, such as an advertiser.

In another aspect, a method comprises determining, via one or more processors on a network, that an activity has occurred and determining, via the one or more processors, whether the activity is an activity that a user of a first device wants to be alerted to upon its occurrence. If the activity is an activity that the user of the first device wants to be alerted to upon its occurrence, the user is alerted by expanding, in a toolbar having a bounded perimeter and comprising a plurality of icons being visibly displayed to the user on the first device, a space associated with an icon in the plurality of icons horizontally along a longitudinal axis of the toolbar for a predetermined amount of time. In one embodiment, the determining that an activity has occurred includes determining that the first device has received an email. In one embodiment, the determining whether the activity is an activity that a user of the first device wants to be alerted to upon its occurrence further includes determining that the email was sent from a sender on a list of senders. In one embodiment, the expanding of the space associated with the icon further comprises displaying the name of the sender.

The determining that an activity has occurred can include determining that a photograph was posted to a social networking site, determining that a photograph was commented on, and/or determining that an on-line music channel was accessed.

In one aspect, a method comprises determining, via one or more processors on a network, that an activity has occurred and determining, via the one or more processors, whether the activity is an activity that a user of a first device wants to be alerted to upon its occurrence. If the activity is an activity that the user of the first device wants to be alerted to upon its occurrence, the user is alerted by changing a display of an icon of a toolbar. The toolbar has a bounded perimeter and comprises a plurality of icons visibly displayed on the first device. Each icon occupies a first space within the bounded perimeter of the toolbar. Upon a selection of the icon by the user (or automatically, such as upon alert), the first space is expanded horizontally along a longitudinal axis of the toolbar to display information in a second bounded space within the perimeter, the information not being visible absent the expansion. In one embodiment, the changing of the display of an icon further includes changing the display of the icon based on settings associated with the user.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a toolbar provider server computer transmitting an enhanced toolbar over a network to a first computer having a network connection with a second computer in accordance with an embodiment of the present invention;

FIG. 2 is a block diagram illustrating the enhanced toolbar of FIG. 1 in accordance with an embodiment of the present invention;

FIG. 3 is a block diagram illustrating the enhanced toolbar of FIG. 2 in accordance with another embodiment of the present invention;

FIG. 4A is a flowchart illustrating steps performed by the first computer of FIG. 1 before alerting the user of the first computer that one or more activity has occurred in accordance with an embodiment of the present invention;

FIG. 4B is a flowchart illustrating steps performed to facilitate providing an embodiment of the enhanced toolbar in accordance with an embodiment of the present invention;

FIG. 5 shows screen shots illustrating the enhanced toolbar of FIG. 1 in accordance with an embodiment of the present invention;

FIG. 6A is a block diagram of an enhanced toolbar in accordance with an embodiment of the present invention; and

FIG. 6B is a block diagram of an enhanced toolbar in accordance with another embodiment of the present invention.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the invention that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

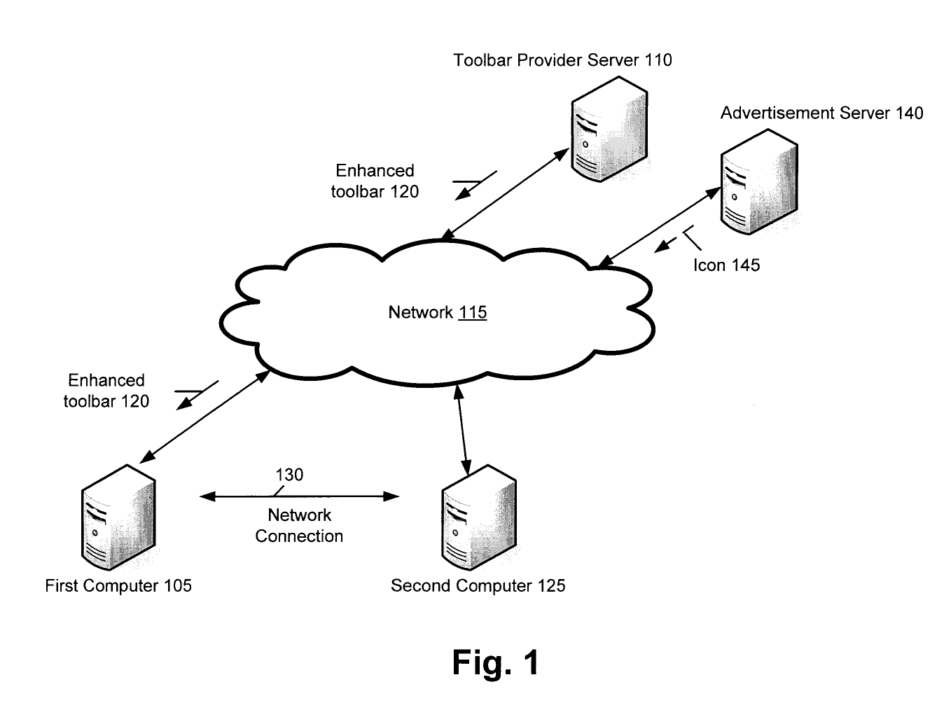

In one embodiment, and referring to FIG. 1, a first computer or computing device 105 is in communication with a toolbar provider server 110 over a network 115, such as the Internet. For purposes of this disclosure, a computer or computing device such as the first computer 105 includes a processor and memory for storing and executing program code, data and software which may be stored or read from computer readable media. Computers can be provided with operating systems that allow the execution of software applications in order to manipulate data. First computer 105 can be any device that can display a website and that can be used by a user. Personal computers, servers, personal digital assistants (PDAs), wireless devices, cellular telephones, internet appliances, media players, home theater systems, and media centers are several non-limiting examples of computers.

For the purposes of this disclosure, a server such as the toolbar provider server 110 comprises software and/or hardware executing on one or more computers which receives information requests from other servers or computers, and responds to such requests. A number of program modules and data files can be stored on a computer readable medium of the server. They can include an operating system suitable for controlling the operation of a networked server computer, such as the WINDOWS VISTA, WINDOWS XP, or WINDOWS 2003 operating system published by Microsoft Corporation of Redmond, Wash., or the Ubuntu operating system distributed by Canonical Ldt. of Douglas, Isle of Mann.

For the purposes of this disclosure, a computer readable medium is a medium that stores computer data in machine readable form. By way of example, and not limitation, a computer readable medium can comprise computer storage media for tangibly storing data, as well as communication media, methods or signals. Computer storage media for tangible storage includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to tangibly store the desired information and which can be accessed by the computer or processor.

In one embodiment, the first computer 105 accesses a web page and downloads an enhanced toolbar 120. Specifically, the toolbar provider server 110 transmits the enhanced toolbar 120 to the first computer 105. In one embodiment, the first computer 105 downloads the enhanced toolbar 120 once and stores the enhanced toolbar 120 locally after its initial download. Thus, after downloading the enhanced toolbar 120, the first computer 105 can display the toolbar 120 each time the browser is displayed and the toolbar provider server 110 can provide updates to the toolbar 120 to the first computer 105, such as periodically or at predetermined times.

In one embodiment, the first computer 105 establishes a network connection 130 with a second computer 125. In another embodiment, the first computer 105 determines that a network connection 130 with the second computer 125 was previously established. As used herein, a network connection 130 between the first computer 105 and the second computer 125 occurs when the user of the first computer (i.e., first user) can determine the status of the user of the second computer (i.e., second user).

For example, this network connection 130 may include, but is not limited to, an instant messaging (IM) friend or contact. In particular, and for example, in an instant messaging system, two users are able to communicate with each other in real time or near real time by passing messages as well as other information, such as files, over the Internet. In an instant messaging system, the messages are generated and displayed using an instant messaging client software program that resides on each user's computer. In some instant messaging systems, other information about the user, such as a profile or his or her status (e.g., whether the user is online, offline, or busy) can be shared with other users of the instant messaging system. This sharing of information between users (e.g., of the first computer and the second computer) is one non-limiting example of a network connection 130 shown in FIG. 1. Other examples include server mediated communication between users' computing devices or direct peer-to-peer communication, or wireless communication via a cellular or wi-fi network.

Typically, the sharing of information between users utilizes and is displayed within the instant messaging system. For example, if the first user is sharing information with the second user via an instant messaging system, the information being shared is typically displayed via an instant messaging client software program that resides on the first computer 105 and the second computer 125. In one embodiment, the enhanced toolbar 120 displays the shared information (e.g., status of the user of the second computer 125). Thus, once a network connection 130 is established, the enhanced toolbar 120 can display information associated with the network connection 130.

The network connection 130 can be used to pass any information between users. For example, social networking activity associated with one or more web pages or web sites may be passed. For example, people can share photographs and/or post comments about photographs. When the second user performs one of these events, the enhanced toolbar 120 can notify the first user that the event occurred. In another embodiment, if the second user begins listening to a particular on-line music channel, the enhanced toolbar 120 can notify the first user that the second user is listening to that particular on-line music channel.

As yet another example, suppose that the second user transmits an email to the first user. In one embodiment, the enhanced toolbar 120 on the first computer displays to the first user that an email has been received from the second user. Thus, unlike existing email notifications in toolbars, which typically display only the number of emails in a user's email inbox, the enhanced toolbar 120 displays the name of the sender of the email and/or at least a portion of the content of the email. Further, once the email is received, the enhanced toolbar 120, in one embodiment, displays this alert for a predetermined amount of time thereafter (or, e.g., until another email is received, for a few seconds or minutes, or after another desired triggering event).

In one embodiment and as described in greater detail below, an advertisement server 140 transmits or pushes an icon 145 to the first computer 105 alone or in cooperation with or via the toolbar provider server 140, to be included in the enhanced toolbar 120. The pushed icon 145 may be an icon associated with an advertisement or an advertiser. As described in more detail below, the pushed icon 145 may be configured in any position in the enhanced toolbar 120. Further, the advertisement server 140 may itself transmit or may work in cooperation with toolbar provider server 140 to transmit multiple icons to the first computer 105 for inclusion in the toolbar 120, such as a new icon 145 every week. In yet another embodiment, the advertisement server 140 transmits information to the first computer 105 for inclusion in the toolbar 120, such as text or graphics (e.g., an advertisement or promotional message).

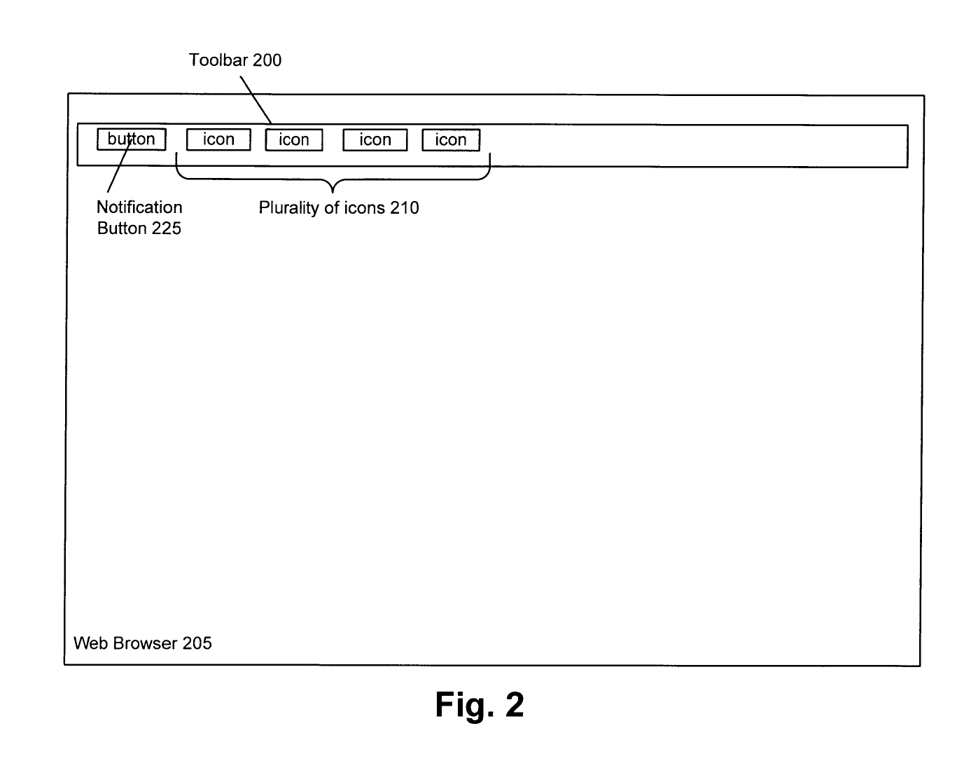

FIG. 2 shows an embodiment of an enhanced toolbar 200 having a bounded perimeter, in a first state, and being visibly displayed by a web browser 205 on a computing device (e.g., the first computer 105). The toolbar may also be part of a web page. The first state of the enhanced toolbar 200 is a typical or first toolbar state in which the toolbar displays a plurality of icons or buttons 210 which are visible. A user of the toolbar 200 can select (e.g., by clicking) an icon in the plurality of icons 210 in order to perform a function, such as to navigate to a particular web site. Further, the icons 210 may be parent or master icons/buttons that are associated with one or more children icons or buttons.

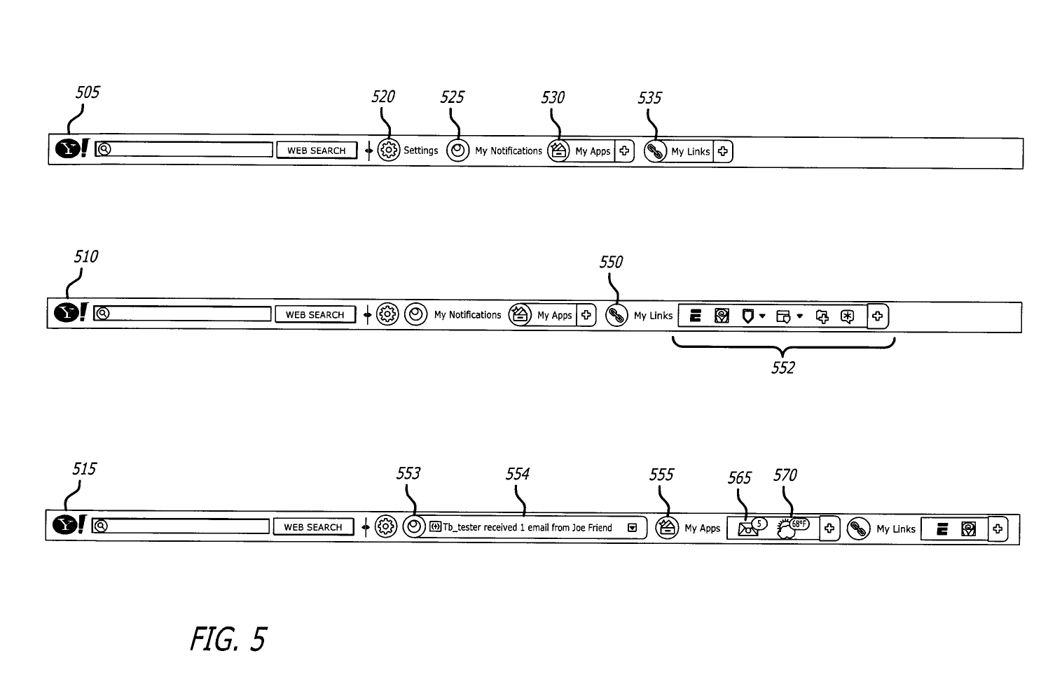

In one embodiment, the enhanced toolbar 200 includes one or more notification buttons or icons, such as notification button 225. The notification button 225 can be, for example, a displayed image of a light that turns on (e.g., a solid light or a flashing light) when there is a notification and is dark (or a different color) when there is no notification. In one embodiment, the notification button 225 provides an alert as to when an activity has been performed by another user (e.g., a second user) that corresponds to a matching activity found in a set of matching activities selected by the first user. The set of matching activities is a list of activities that are selected by the first user. When an activity is performed by the second user, the enhanced toolbar 200 provides a notification if the activity matches one of the activities in the set of matching activities selected by the first user. For example, suppose that the first user wants to be alerted when receiving an email from the second computer 125. The first user can select this activity from a set or list of activities. Examples of other such activities a user may desire to be alerted to include, but are not limited to, updates to social networking sites, updates to a user's blog, updates to a photograph site, updates to a community web page, to provide just a few examples. Then, once the first computer 105 receives an email from the second computer 125, the notification button 225 can alert the first user that a selected activity in the list of activities has occurred. In one embodiment (and as shown in FIG. 5), the enhanced toolbar 200 can display that the received email was from the second user. In yet another embodiment, the toolbar 200 displays at least a portion of the content of the received email.

In another embodiment, the enhanced toolbar 200 provides a notification of the IM status of the user of the second computer, such as whether the user is online, offline, or busy. In yet a further embodiment, if the user of the second computer 125 is listening to music (e.g., a particular song), the enhanced toolbar 200 can provide a notification to the user of the first computer as to what music the user of the second computer 125 is listening. Although shown with one notification button 225, the enhanced toolbar 200 can have any number of notification buttons. The notification button 225 can therefore provide notifications or alerts based on the user's social graph, mail updates, and/or from other notification engines, such as Yahoo!® Alerts provided by Yahoo! Inc. of Sunnyvale, Calif. Thus, the enhanced toolbar 200 provides information to a user dynamically, regardless of the web page that the browser 205 is displaying.

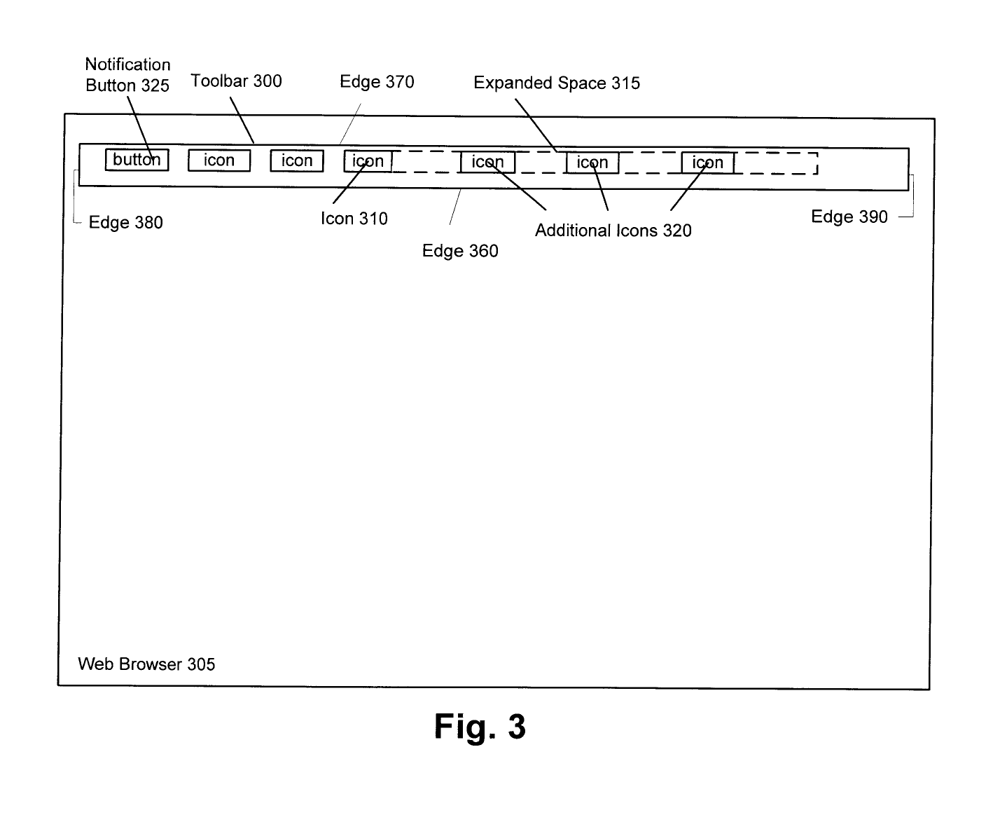

FIG. 3 shows an embodiment of the enhanced toolbar 300 in a second state being displayed by web browser 305 on a computing device (e.g., the first computer 105). In this embodiment, a user of the toolbar 300 selects icon 310 (e.g., by using the mouse pointer to click on the icon 310 or hover over the icon 310). Upon the selection of icon 310, the space associated with, or immediately surrounding or proximate the icon 310 expands horizontally along a longitudinal axis of the enhanced toolbar 300 to an expanded space 315. The expanded space 315 may display any type of information, such as text, web links and/or icons. The information displayed may be based on past activity of the first user or may be based on activities of other users (e.g., the second user) or alerts that activities are occurring. In one embodiment, the expansion occurs in such a manner as to provide the visible appearance of a drawer or slide cover opening to reveal other icons “behind the sliding cover” or “in the drawer”. The expanded space 315 can be to the left of and/or to the right of the selected icon 310. As shown, the expanded space 315 “overlays” or visibly replaces at least some of the plurality of icons 210 shown in FIG. 2 to display additional icons 320. In other words, the expanded space 315 causes new icons (e.g., additional icons 320) or other information to be shown. In one embodiment, the additional icons 320 are shown over at least one of the previously viewed plurality of icons 210 of FIG. 2. In another embodiment, the additional icons 320 move or push the previously viewed icons over (e.g., to the right) so that the previously viewed icons are still viewable but are next to the additional icons 320.

Although illustrated as appearing to the right of the icon 310, the expanded space 315 can appear to the left of the icon 310 or to both the right and the left of icon 310 (e.g., icon 310 is within the expanded space 315). Thus, the expanded space 315 can be used to increase the toolbar space in which icons can be displayed, or to give that impression, or fewer but more topical or specific icons may be displayed in the expanded region. In an embodiment, the expanded space 315 remains within a bounded perimeter of the displayed toolbar 300, that is it does not extend beyond edges 360, 370, 380 and 390. As a result, the expanded space 315 can increase or decrease the number of icons that can be displayed at any time via toolbar 300.

In one embodiment, the icons displayed in the expanded space 315 may vary over time, such as a first icon being displayed for three months and then a second icon being displayed where the first icon was displayed after the three months are over. This change from the first icon to the second icon can be a result of the actions performed by a user of the toolbar 300. For example, suppose, over a three month period, that a first icon is being displayed in the expanded space 315. The first icon is a shortcut to www.cnn.com. Suppose further that during these three months, the user does not click on the first icon once but does navigate to www.yahoo.com frequently during the same three month period. In one embodiment, the toolbar provider server 110 can update the enhanced toolbar 300 by replacing the first icon from the expanded space 315 with a new icon being a shortcut for www.yahoo.com because the first icon is not being utilized by the user of the toolbar. In embodiments, the icons can change as a result of breaking news, new blog postings or RSS feed updates subscribed to by the user, stock price fluctuations, new music releases or other subscribed-to alerts or notifications. Also, the provider of the toolbar can periodically push icons that represent sponsored or paid-for advertising by third parties. Thus, as further described below, advertisers or sponsors can pay to have icons inserted into the toolbar, and when clicked reveal messages or offers in the expanded space.

In one embodiment, the toolbar provider server 110 includes a relevancy engine that determines what icons the expanded space 315 should include. For example, the relevancy engine determines over a period of time what actions the user takes, and configures the expanded space 315 to contain icons associated with the user's actions. In a further embodiment, the relevancy engine determines what the toolbar 200, 300 displays (e.g., the expanded space 315) based on other people's (e.g., an IM friend's) actions. For example, suppose that the user of the first computer 105 is interested in sports. The relevancy engine can determine that the user of the second computer 125 also likes sports and often utilizes a particular icon to traverse to a particular web page (e.g., www.espn.com). The relevancy engine (i.e., toolbar provider server 110) can recommend this icon (associated with www.espn.com) to the user of the first computer 105. In one embodiment, the relevancy engine changes the toolbar 200, 300 dynamically over time based on this inference that the user of the first computer will use an icon associated with www.espn.com. The toolbar 200, 300 can be updated dynamically based on what the user of the first computer 105 has done in the past and/or based on what other people having similar interests to the first user have done in the past.

Thus, a user's behavioral information, gathered explicitly by user preference polling or response to questionnaire(s), or implicitly from observed behavior, can be used to push icons that relate to information relevant to the user. This information can be leveraged by the toolbar provider by using it to offer to advertisers who would pay to have certain icons pushed to users based on behavioral information. The pushed icon, when selected by the user, would result in the expanded region displaying a message or link to a site related to the advertisement.

In one embodiment, the icons 320 displayed in the expanded space 315 can be changed via expanded space controls (e.g., arrow buttons). For example, a right arrow button may be provided in the expanded space 315 that, when pressed once, displays one new icon and moves the other icons 320 over one space. In one embodiment, this carousal movement can occur on either side of the enhanced icon space 315.

In one embodiment, the web browsing history from within the web browser 305 can be processed to provide customized recommendations across a set of objects/toolbar icons. Such recommendations would be specifically tailored to that user's interests and based on the user's web browsing history. In one embodiment, a web site is utilized to enable the first user to select one or more icons or buttons that the first user would like to include in the enhanced toolbar 200, 300.

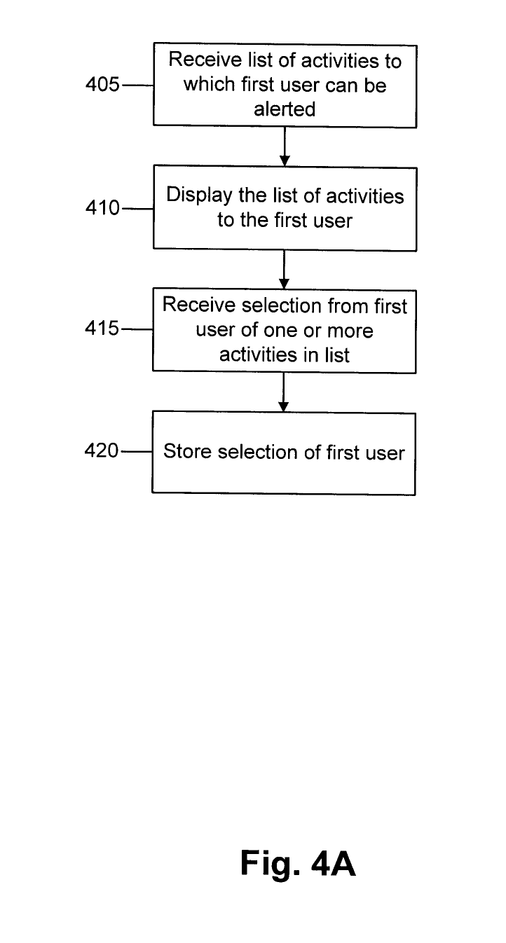

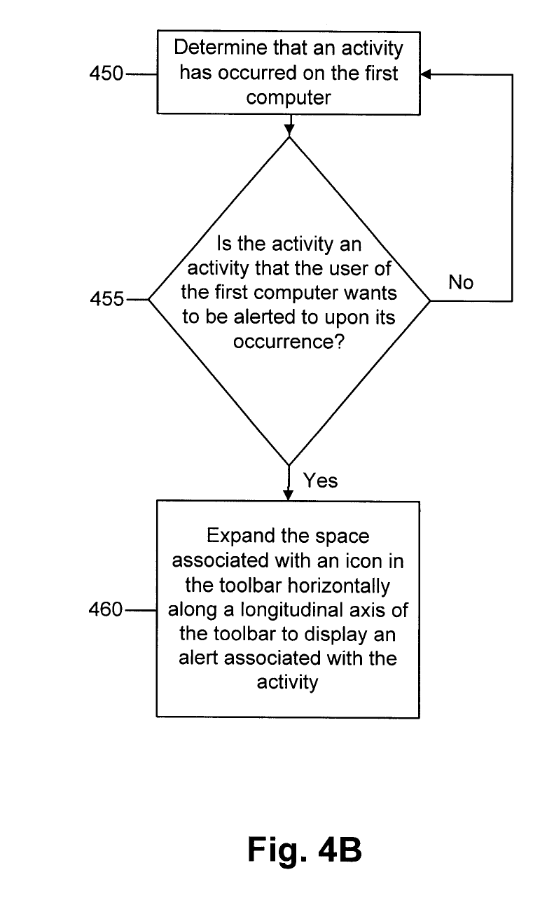

FIG. 4A illustrates steps performed by the first computer 105 before alerting the first user via an icon that one or more activity has occurred. The first computer 105 receives, in step 405, a list of activities to which the first user can be alerted. In step 410, the first computer 105 displays the list of activities to the first user. The first computer 105 receives (step 415) a selection from the first user of one or more activities in the list. The selection associated with the first user is then stored. In one embodiment, the selection is stored at the first computer 105 (e.g., as part of the enhanced toolbar or in a user database). In another embodiment, the selection is transmitted to and stored by the toolbar provider server 110. In yet another embodiment, the selection is stored by a third party.

FIG. 4B illustrates steps performed to facilitate providing an embodiment of the enhanced toolbar. In one embodiment, the toolbar provider server 110 (or the first computer 105) determines in step 350 that an activity has occurred on the first computer 105. The toolbar provider server 110 (or the first computer 105) then determines, in step 355, whether the activity is an activity that a user of the first computer 105 wants to be alerted to upon its occurrence. If the activity is an activity that the user of the first device wants to be alerted to upon its occurrence, the toolbar provider server 110 (or the first computer 105) changes the display of an alert icon. In one embodiment, if the alert icon is selected (e.g., clicked on or hovered over), the toolbar provider server 110 (or the first computer 105) then expands (step 360) the space associated with an icon in the enhanced toolbar 120 horizontally along a longitudinal axis of the toolbar for a predetermined amount of time to display an alert associated with the activity. In another embodiment, the toolbar provider server 110 (or the first computer 105) changes the display of the alert icon and automatically expands the space associated with an icon in the enhanced toolbar 120 in the fashion described above.

FIG. 5 is a diagram indicating several embodiments of enhanced toolbar 505, 510, 515 displayed via a display of the first computer. In one embodiment, the enhanced toolbar 505, 510, 515 includes a plurality of core icons that provide the notifications described above and/or enable access to one or more other icons as described above. For example, enhanced toolbar 505 has four core icons: a settings icon 520, an alert icon 525, an applications icon 530, and a links icon 535. In one embodiment, the settings icon 520 displays the IM status of the user of the first computer 105, such as whether the user is signed in to IM or signed off of IM. For example, the settings icon 520 can be a different color when the user is signed in to IM.

In one embodiment and as described in more detail below with respect to enhanced toolbar 515, the alert icon 525 is in the form of a bulb or light emitting diode image that “lights up” or changes color when an activity selected by the first user occurs. In one embodiment, the first user has a list of activities to choose from. Once an activity is selected from the list, the alert icon 525 alerts the first user of its occurrence.

In one embodiment and as described in more detail below with respect to enhanced toolbar 515, the applications icon 530 provides access to a plurality of additional icons. Specifically, when the applications icon 530 is selected, the space associated with or surrounding or proximate the applications icon 530 expands horizontally in one or both directions along a longitudinal axis of the enhanced toolbar to display the additional icons. In one embodiment, the icons displayed when the applications icon 530 is selected are a predetermined set of icons.

In one embodiment, the links icon 535 enables access to a plurality of additional icons. Referring to the enhanced toolbar 510, the links icon 550 has been selected by the first user (e.g., by using the mouse pointer to click on the links icon 550 or by hovering with the mouse pointer over the links icon 550). The selection of the links icon 550 results in a plurality of additional icons 552 being displayed. In one embodiment, one or more of the plurality of additional icons 552 are selected by the first user for display when the links icon 550 is selected.

Referring to the enhanced toolbar 515, in one embodiment alert icon 553 alerts the first user that the selected activity or one of a plurality of selected activities has occurred. For example and as described above, suppose the first user selects to be notified when receiving an email. The enhanced toolbar 515 illustrates this embodiment with an email alert 554 indicating that the first user (shown as Tb_tester) has received an email from second user Joe Friend. In one embodiment, the core icon(s) typically adjacent to the alert icon 553 are pushed to the right of the email alert 554. In another embodiment, when an alert occurs (such as the email alert) or when additional icons are displayed (such as additional icons 565, 570), the core icons typically next to the selected icon (in enhanced toolbar 515, the alert icon 553) are covered by the alert (e.g., email alert) and are visible again after a predetermined time has elapsed or the expanded section is closed by the first user.

Enhanced toolbar 515 illustrates an embodiment when applications icon 555 is selected. In one embodiment, common icons 565, 570 are displayed. In one embodiment, common icons 565, 570 include an email icon 565 indicating how many email messages the first user has in his or her inbox or how many email messages the first user has received that have not yet been read. Common icons 565, 570 may also be associated with web links, such as a weather icon 570 indicating the current temperature and/or associated with a weather web page. Although shown with four core icons, the enhanced toolbar may have any number of core icons providing any number of notification(s) and/or access to any number of other icons.

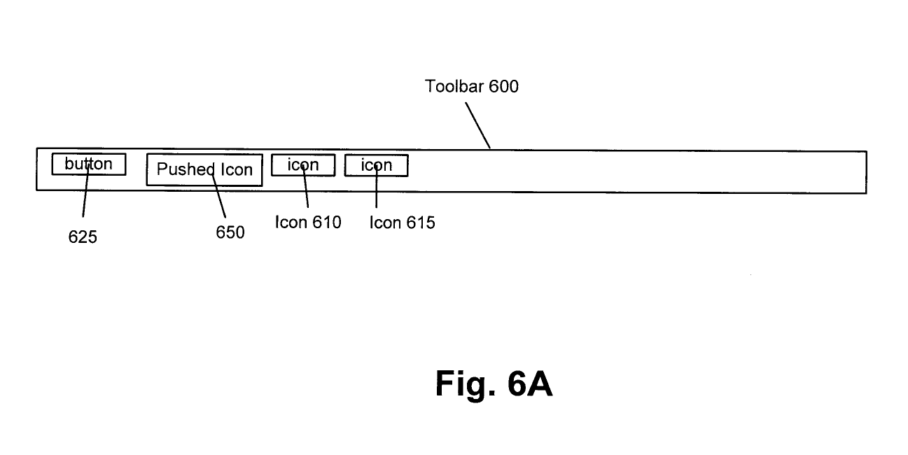

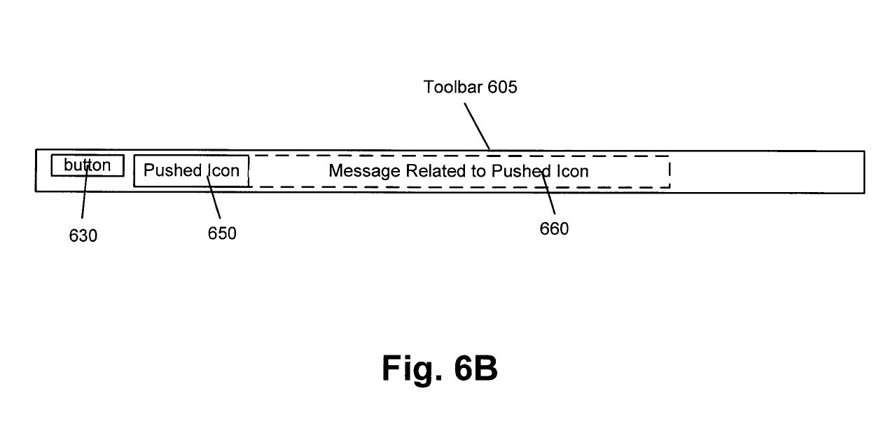

FIGS. 6A and 6B show two embodiments of enhanced toolbar 600, 605. Enhanced toolbar 600 includes icons 610, 615 and a button 625. Enhanced toolbar 600 also includes a pushed icon 650 which may be pushed from an advertiser or sponsor alone or in concert with the toolbar provider (see servers 110 and 140 in FIG. 1), as described above. In one embodiment, when the first user selects (e.g., clicks on or hovers over) the pushed icon 650, a message 660 related to the pushed icon can be displayed (as shown in enhanced toolbar 605). In one embodiment advertisers can push promotion-related icons 650 to the enhanced toolbar 600, 605 based on relevancy to the user (or other factors). When the pushed icon 650 is selected by the user, the space expands (e.g., “the drawer opens”) and can reveal an offer or promotional message (e.g., for the first user to click). The pushed icon 650 can be any size and shape. Further, advertisers can push new buttons or icons 650 to the enhanced toolbar 600, 605 over time.

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the first or second computers or server or both. In this regard, any number of the features of the different embodiments described herein can be combined into single or multiple embodiments, and alternate embodiments having fewer than, or more than, all of the features described herein are possible. Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

The foregoing Description is to be understood as being in every respect illustrative and exemplary, but not restrictive, and the scope of the invention disclosed herein is not to be determined from the Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A user interface visibly displayed on a display of a computing device comprising:
a toolbar having a bounded perimeter and comprising a plurality of icons being visibly displayed on the display, each icon occupying a first space within the bounded perimeter of said toolbar,
wherein, upon a selection of a first icon in the plurality of icons by a user, said first space associated with the first icon expands horizontally along a longitudinal axis of said toolbar to display information in a second bounded space within said perimeter, said information not being visible absent said expansion.

2. The user interface of claim 1 wherein the information comprises information chosen from a group of information consisting of text, a web link, and one or more additional icons.

3. The user interface of claim 1 wherein the information displayed is based on past activity of a user accessing the toolbar.

4. The user interface of claim 1 further comprising a relevancy engine in communication with the toolbar and configured to change the information displayed.

5. The user interface of claim 4 wherein the relevancy engine is further configured to change the information based on past activity of one or more other users different than the user.

6. The user interface of claim 1 wherein the toolbar indicates an alert to a first user that an activity has been performed by a second user.

7. The user interface of claim 6 wherein the alert further comprises an indication that an email has been sent from the second user to the first user.

8. The user interface of claim 6 wherein the alert is configured based on settings received from the first user.

9. The user interface of claim 1 wherein the information displayed changes after a period of time.

10. The user interface of claim 1 further comprising a control configured to change the information being displayed.

11. The user interface of claim 1 wherein one or more icons in the plurality of icons is received from an advertisement server.

12. The user interface of claim 1 wherein the information displayed in the second bounded space is received from an advertisement server.

13. The user interface of claim 1 wherein one or more icons in the plurality of icons is received from a toolbar provider server.

14. The user interface of claim 1 wherein the information displayed in the second bounded space is received from a toolbar provider server.

15. A method comprising:
determining, via one or more processors on a network, that an activity has occurred;
determining, via said one or more processors, whether the activity is an activity that a user of a first device wants to be alerted to upon its occurrence;
if the activity is an activity that the user of the first device wants to be alerted to upon its occurrence,
alerting the user by expanding, in a toolbar having a bounded perimeter and comprising a plurality of icons being visibly displayed to the user on the first device, a space associated with an icon in the plurality of icons horizontally along a longitudinal axis of the toolbar for a predetermined amount of time.

16. The method of claim 15 wherein the determining that an activity has occurred further comprises determining that the first device has received an email.

17. The method of claim 16 wherein the determining whether the activity is an activity that a user of the first device wants to be alerted to upon its occurrence further comprises determining that the email was sent from a sender on a list of senders.

18. The method of claim 17 wherein the expanding a space associated with an icon in the plurality of icons horizontally along a longitudinal axis of the toolbar for a predetermined amount of time further comprises displaying the name of the sender.

19. The method of claim 15 wherein the determining that an activity has occurred further comprises determining occurrence of at least one activity chosen from a group of activities consisting of a photograph being posted to a social networking site, a photograph on a photograph website being commented on, and that an on-line music channel was accessed.

20. A method comprising:
determining, via one or more processors on a network, that an activity has occurred;
determining, via said one or more processors, whether the activity is an activity that a user of a first device wants to be alerted to upon its occurrence;
if the activity is an activity that the user of the first device wants to be alerted to upon its occurrence,
alerting the user by changing the appearance of a display of an icon of a toolbar, the toolbar having a bounded perimeter and comprising a plurality of icons visibly displayed on the first device, each icon occupying a first space within the bounded perimeter of said toolbar; and
expanding the first space horizontally along a longitudinal axis of the toolbar to display information in a second bounded space within said perimeter, said information not being visible absent said expansion.

21. The method of claim 20 wherein the expanding the first space horizontally along a longitudinal axis of the toolbar to display information in a second bounded space within said perimeter further comprises expanding the first space horizontally along a longitudinal axis of the toolbar to display information selected from the group consisting of text, a web link, and an additional icon in a second bounded space within said perimeter.

22. The method of claim 20 wherein the determining that an activity has occurred further comprises determining that an activity by a second user has occurred.

23. The method of claim 20 wherein the determining whether the activity is an activity that a user of a first device wants to be alerted to upon its occurrence further comprises storing a selection by the user of one or more activities that the user wants to be alerted to.

24. The method of claim 23 wherein the storing further comprises storing the selection at the first device.

25. The method of claim 20 wherein the changing of the display of an icon further comprises changing the display of the icon based on settings associated with the user.

26. The method of claim 20 further comprising receiving, from an advertisement server, one or more icons in the plurality of icons.

27. The method of claim 20 further comprising receiving, from an advertisement server, the information displayed in the second bounded space.

28. The method of claim 20 further comprising receiving, from a toolbar provider server, one or more icons in the plurality of icons.

29. The method of claim 20 further comprising receiving, from a toolbar provider server, the information displayed in the second bounded space.

30. The method of claim 20 wherein the expanding occurs upon a selection of the icon by the user.

31. The method of claim 20 wherein the expanding occurs automatically upon alert.

32. A computer readable medium comprising computer code which implements the following procedures:
determining that an activity has occurred;
determining whether the activity is an activity that a user of a first device wants to be alerted to upon its occurrence;
if the activity is an activity that the user of the first device wants to be alerted to upon its occurrence,
alerting the user by changing a display of an icon of a toolbar, the toolbar having a bounded perimeter and comprising a plurality of icons visibly displayed on the first device, each icon occupying a first space within the bounded perimeter of said toolbar; and
expanding the first space horizontally along a longitudinal axis of the toolbar to display information in a second bounded space within said perimeter, said information not being visible absent said expansion.

33. The computer readable medium of claim 32 wherein the computer code defining the step of expanding the first space further comprises computer code defining the step of expanding the first space upon a selection of the icon by the user.

34. The computer readable medium of claim 32 wherein the computer code defining the step of expanding the first space further comprises computer code defining the step of automatically expanding the first space upon alert.

35. A system comprising:
a toolbar provider server configured to transmit to a computing device a toolbar having a bounded perimeter and comprising a plurality of icons being visibly displayed on a display of the computing device, each icon occupying a first space within the bounded perimeter of said toolbar; and
an advertisement server configured to provide content for addition to the toolbar,
wherein, upon a selection of a first icon in the plurality of icons by a user, said first space associated with the first icon expands horizontally along a longitudinal axis of said toolbar to display information in a second bounded space within said perimeter, said information not being visible absent said expansion.

36. The system of claim 35 wherein the advertisement server is further configured to transmit the information displayed in the second bounded space to the computing device.

37. The system of claim 35 wherein the toolbar provider server is further configured to provide content for addition to the toolbar.

38. The system of claim 35 wherein the toolbar provider server is further configured to transmit the information displayed in the second bounded space to the computing device.
